(19) United States
(12) Patent Application Publication
(10) Pub. No.: US 2010/0214079 A1
(43) Pub. Date: Aug. 26, 2010

(54) METHOD FOR SWITCHING AN RFID TAG FROM DEEP SLEEP TO ACTIVE MODE

(75) Inventor: Oliver Desjeux, Le Landeron (CH)

Correspondence Address: LERNER GREENBERG STEMER LLP, P O BOX 2480, HOLLYWOOD, FL, 33022-2480, US

(73) Assignee: INGECOM SARL, La Neuveville (CH)

(21) Appl. No.: 12/705,178

(22) Filed: Feb. 12, 2010

(30) Foreign Application Priority Data
Feb. 25, 2009 (EP) 09 153 620.1

(51) Int. Cl. H04Q 5/22

(52) U.S. Cl. 340/10.34

(57) ABSTRACT

A method by which an active tag can be switched from a deep sleep mode to an operating mode is based on a detector embedded on an active tag providing a wake up pulse to a state-machine of the tag in response to external energy pulse that will open an radio frequency listen window in which a reader can send any usual command, among them a wake-up command or a configuration command.

### CROSS-REFERENCE TO RELATED APPLICATION

This application claims the priority, under 35 U.S.C. §119, of European application EP 09 153 620.1, filed Feb. 25, 2009; the prior application is herewith incorporated by reference in its entirety.

### BACKGROUND OF THE INVENTION

### Field of the Invention

The present invention relates to a method for switching an RFID tag from a deep sleep mode to an active mode and to an active RFID tag as an implementation of the method.

An RFID active tag 1 is an electronic device with at least an antenna 80, a battery 90, a transmitter unit 70 (or also denoted by transceiver unit 70) and a state machine or microcontroller unit 60 as principally depicted in FIG. 1. In its most common format, the transmitter 70 transmits information (e.g. telegrams) on the radio frequency (RF) at predetermined intervals, therefore switches regularly from a transmit mode to a sleep mode. Many implementations are already on the market from companies such as SAVI, Wavetrend, Coronis, Identec, Ingecom, or other ones. This prior art product has already several differentiations in the way the telegram is broadcasted, whether it is transmitted on a regular or random interval, whether if it can be kept in silent state or not.

The tags already on the market operate in a <<propagating mode>> with a coupled E/H-field, e.g. at frequencies compatible with this mode of operation, like typically above 300 MHz, called RF in this current document. This mode of transmission allows for long reading distances, with tags that are not necessarily organized as facing the interrogator, like is the case for passive tags operating with a magnetic coupling between the interrogator and the tag.

For the sake of clarity only the terms <<transmit state>>, <<silent state>>, <<active mode>> and <<deep sleep mode>> with the before mentioned definitions are consistently used in the following text. The <<transmit state>> and the <<silent state>> are considered as part of the <<active mode>>.

The basic principle of the active tag, and the way it operate for several years without draining the battery, is by keeping a so called <<silent state>> between the RF transmissions. The <<silent state>> is done by keeping the state machine in a very low power consumption mode, typically below 0.5 μA in the case of the Ingecom active tags; http://www.ingecom.ch. In this silent state, the active tag is not transmitting its telegrams. The state machine remains in operation with a low-power counter used to determine the next transmission time. Depending on the implementation, some listen windows may be activated to check for a potential incoming telegram from a reader, see FIG. 2.

On the other hand a <<transmit state>> or an <<active mode>> or a <<beaconing state>> or a <<propagating mode>> or an <<operating mode>> denotes the opposite of the <<silent state>>. In the <<silent state>> the tag is not transmitting, but may be listening periodically to verify if any incoming telegram should be interpreted. The <<deep sleep mode>> is a mode in which all the activity of the state machine is not activated, not even a timer, not even a listening window. The tag can get out of this <<silent mode>> mode by an external solicitation. A typical current consumption in <<silent mode>> is in the range of 200 nA for polarization for the Ingecom active tags.

The <<silent state>> of the active tag is basically a state in which the tag is not transmitting its telegram 100 by the transmitting section Tx. However, an active tag must periodically wake up—see sequence 101 in FIG. 2—its receiving section Rx in order to make sure that the reader is not sending any command that would result, presumably, in switching from the <<silent state>> to the <<transmit state>> 104. FIG. 2 describes a typical RF sequence, under supervision of the reader, which changes the state of operation 103, 104 of the tag 1.

Unfortunately, the periodic wake-up 101 of the receiving section Rx of the active tag 1 generates a very significant contribution to the overall energy consumption of the active tag 1. The receiving section Rx of a typical RF transceiver is sinking approximately the same order of magnitude of energy as what is required to transmit telegrams, see sequence 100 in FIG. 2. So, placing the tag 1 in a silent state is generally not providing any benefit to the overall lifetime of the battery 90 of the active tag 1, despite what would be expected by the users.

The current document addresses the specific requirement of placing the active tag 1 in a <<deep sleep mode>> as explained above. This feature is particularly useful especially during the production in order to be able to test individually the RF characteristics of all the tags without having the other tags corrupting the production measurement. It is equally important to keep the tags free from transmission during the whole logistic process, especially during the air transport period.

The <<deep sleep mode>> is a mode in which all the activity of the state machine is de-activated, not even a timer nor a listening window are in use. The tag can get out of this <<deep sleep mode>> only by an external solicitation. A typical current consumption in <<deep sleep mode>> is in the range of 200 nA, in the case of the Ingecom active tags.

U.S. Pat. No. 7,446,658 B2 discloses a tag containing a motion sensor in order for a switch from active mode to a deep sleep mode. This solution is limited for a specific use and not in general applicable, since during a transport phase these tags may inadvertently be activated/deactivated randomly.

In U.S. patent publication No. 2003/0104848 A1 a RFID device is disclosed, being protocol compatible with RFID, Bluetooth and/or IEEE 802.11X infrastructure. A protocol processor services RFID and transceiver sections and is coupled to the antenna via a backscatter switch. For reception, the RFID section utilizes demodulation techniques and provides a wake up mode within a predetermined distance of the interrogator.

The receiver wake up according to U.S. patent publication No. 2005/0150949 A1 requires a threshold adapter and a comparator. The incoming signal is analyzed, if it is indeed a wake-up signal destined for that tag.

U.S. patent publication No. 2005/0093374 A1 describes a power supply of a circuit using an externally applied magnetic field. This solution is not appropriate for waking up an RFID-Tag.

### SUMMARY OF THE INVENTION

It is accordingly an object of the invention to provide a method for switching an RFID tag from a deep sleep mode to an active mode which overcome the above-mentioned disadvantages of the prior art methods and devices of this general type, and to make sure that the method is available to wake-up the tag from the deep sleep mode without adding any significant cost to the product, and without necessity to open the case.

With the foregoing and other objects in view there is provided, in accordance with the invention an active RFID tag. The tag includes a microcontroller, an antenna, a transmitter connected to the antenna, a battery, and a detector for receiving an external energy pulse providing a wake-up pulse to the microcontroller. The wake-up pulse has an effect of opening a brief radio frequency listen window allowing the active RFID tag to receive a message containing an instruction to switch to an active mode.

The solution described here is based on an energy detector responsive to an external trigger or energy transfer. The energy detector may be in the form of a 13.56 MHz peak detector or in the form of a capacitive coupler. For a first embodiment a 13.56 MHz receiving antenna is placed inside the active tag. Upon reception of the triggering signal, a simple carrier, the tag will open a listen window on the RF channel. During the listening time, the tag shall receive the instruction, from its reader, to change mode. It will then switch to the regular active mode. The advantages of the invention are now briefly discussed.

The first advantage of this method is that the tag doesn't have any mechanical contact to the outside world, therefore the case can be permanently closed and waterproof tested.

The second advantage is to keep the energy consumption very low. The tag is in the <<deep sleep mode>>, and doesn't require more than 200 nA of current until it is solicited by the 13.56 MHz carrier or by a capacitive energy transfer. Upon solicitation, the tag listens on the RF channel during a very brief time frame, typically 200 micro-seconds, and interprets an incoming message if there is one. In case no message is inbound, the tag returns to the deep sleep mode. Only very little energy is used for this operation in case of false triggering by the 13.56 MHz triggering signal. The second advantage can also formulated as now described. Only a simple trigger is enough to open a listening window. Whether the listening window is used to receive and interpret a command, or not used, doesn't impact the function and performance of the tag. The interpreted command can be, for example, a wake-up command. It can also simply be a GET-ID command, simply to retrieve the ID of the tag for the purpose of identification.

The third advantage is that any configuration command can also be sent during this listen window, hence allowing the tag to wake-up in different configurations of transmissions and/or reception.

The fourth advantage is that the tag remains silent, therefore unnoticed, on the RF channel upon triggering.

The invention also solves the problem of air-transporting the tags, during which the IATA requires that no intentional radiator may be used. Another usage is for the storage of the tags in the warehouse in the deep sleep mode, without having an impact on the battery lifetime of the tag. So the storage of the tag can be done, allowing for significant production batches to be produced, still ensuring that the end-user shall receive tags with a fresh new battery with a quick wake-up before shipment. This specific telegram requires having a hardware implementation with additional components as compared to a simple peak detector as described herein, hence, would require to increase the individual active tag's production price, which is not desirable.

A more elaborated concept is found in U.S. Pat. No. 6,765,484 B2 and international patent disclosure WO2007/101080 A2 (corresponding to U.S. patent publication No. 2007/0205873), where the LF receiver is able to decode the telegrams sent by the LF transmitter. The benefit of having only a detector in the method according to the invention is that the overall implementation cost is dramatically reduced. The LF detector is considered only as a simple switch.

The principle of waking up a tag is not new. In European patent EP 1 210 693 B1, corresponding to U.S. Pat. No. 7,143,049, there is also a method disclosed, by which an electronic ticket—also to be considered as a tag—receives a wake-up telegram on a frequency of 13.5 MHz, but this is more than just a transfer of energy. This telegram contains specific information regarding the subsequent bidirectional communication on a higher frequency. The invention here uses the wake up telegram without any information just to open a receiving window. This represents a significant simplification. This solution was for European patent EP 1 210 693 B1 since a plurality of tags had to be traced.

Other features which are considered as characteristic for the invention are set forth in the appended claims.

Although the invention is illustrated and described herein as embodied in a method for switching an RFID tag from deep sleep to active mode, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a typical active tag structure according to the prior art;

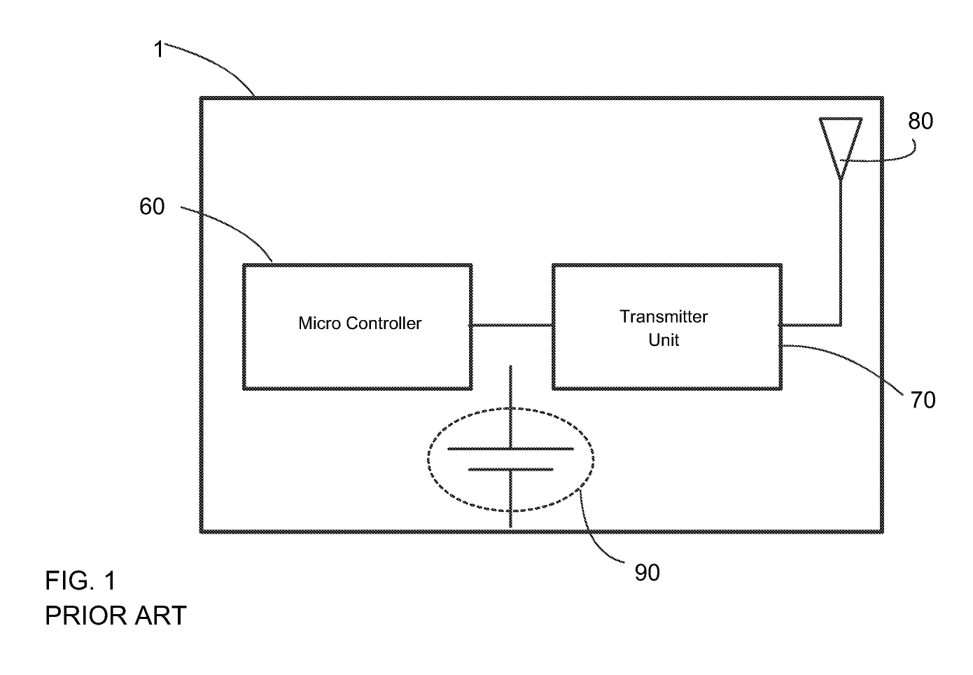

FIG. 2 is an illustration of a typical active tag sequence from a transmit state to silent state according to the prior art;

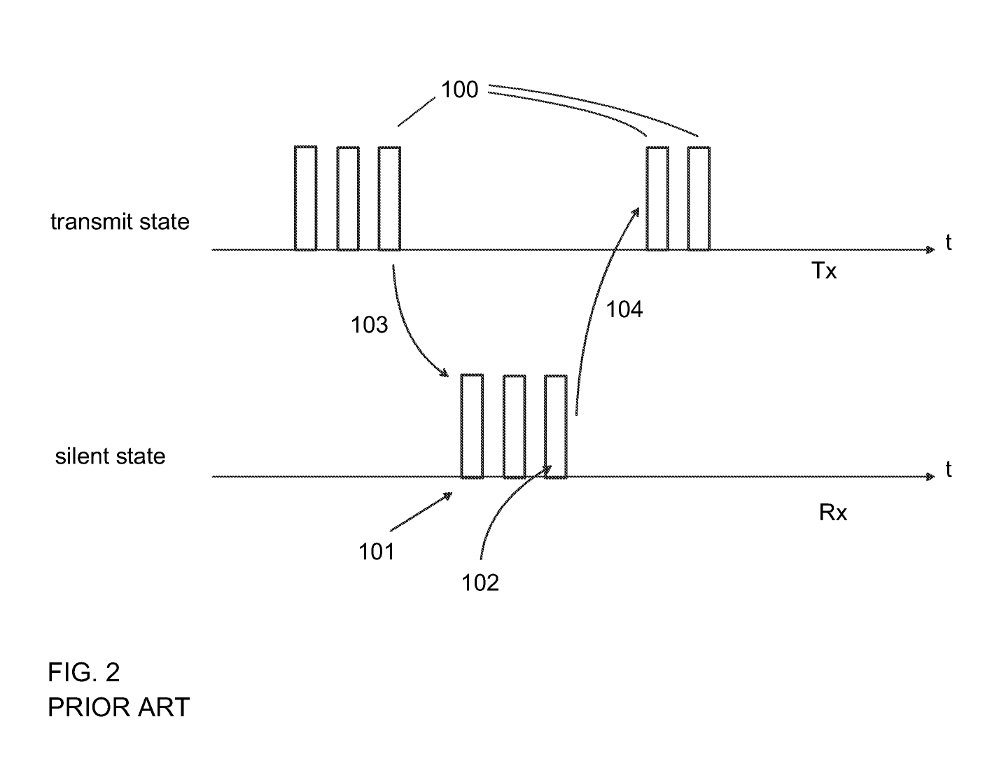

FIG. 3 is a schematic diagram of an active tag with a LF field detector for waking up according to the invention;

FIG. 4 a schematic diagram of an active tag with two plates for a capacitive coupling for waking up; and

FIG. 5 is state/event diagram for toggling from an active mode to a deep sleep mode with a LF field detector.

### DETAILED DESCRIPTION OF THE INVENTION

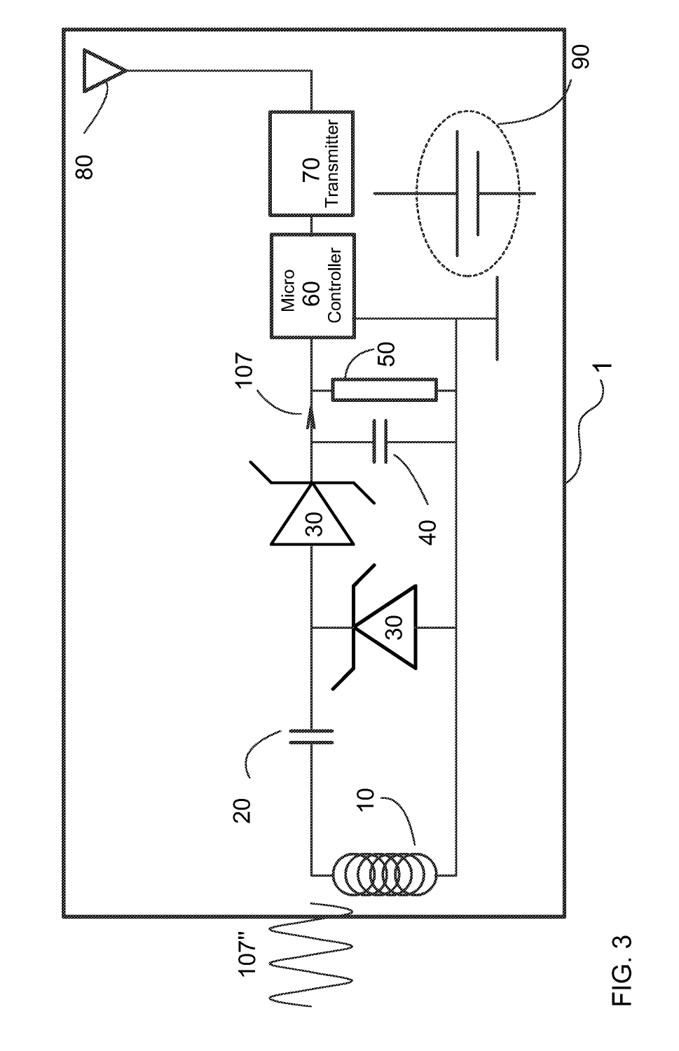

Referring now to the figures of the drawing in detail and first, particularly, to FIG. 3 thereof, there is shown a principle of the invention being explained via a first embodiment. An active tag 1 is fitted with a simple low-frequency detector formed by a coil 10, a peak-detector formed by a capacitor 20 and two Schottky diodes 30. A further capacitor 40 is loaded with a resistor 50, details see FIG. 3. The detector reacts to a magnetic field crossing 107″, the coil 10 being set at a low-frequency, e.g. 13.56 MHz, and generates an input that is detected as an interrupt by the state machine of the active tag 1. This simple low-frequency detector allows the tag 1 to be placed in a deep sleep mode with a current consumption of less than 200 nA requiring only the activation of the trigger to switch back to the active mode. The exact working principle of the before mentioned peak-detector with the Schottky diodes is disclosed in published, European patent application EP 1 645 994 A1, corresponding to U.S. Pat. No. 7,515,050. The magnetic field crossing the coil 10 is typically from a close contact reader according to ISO 14443 or ISO 15693.

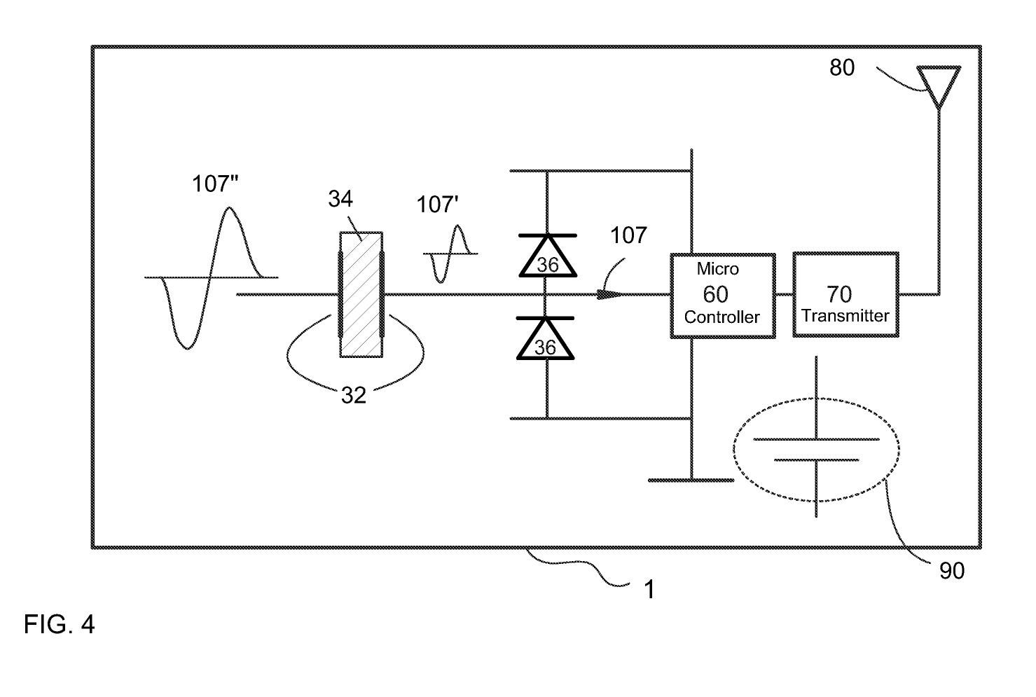

In a second implementation according to FIG. 4, a capacitive coupling is used. It has to be noted that FIG. 4 shows a schematic view, but not a constructive view of the second implementation. The capacitive coupling can be done simply between both faces of the active tag 1. In this case the triggering pulse 107″ would be transferred between an outside plate from the trigger, to a permanent inside plate fitted on the active tag 1. The detector is formed by two plates 32 and a plastic case 34. Since by capacitive coupling a relatively considerable amount of energy, even an attenuated triggering pulse 107′, may be transmitted limiter diodes 36 are placed in order to protect the microcontroller 60; see in a qualitative manner the pulses 107″, 107′ in FIG. 4.

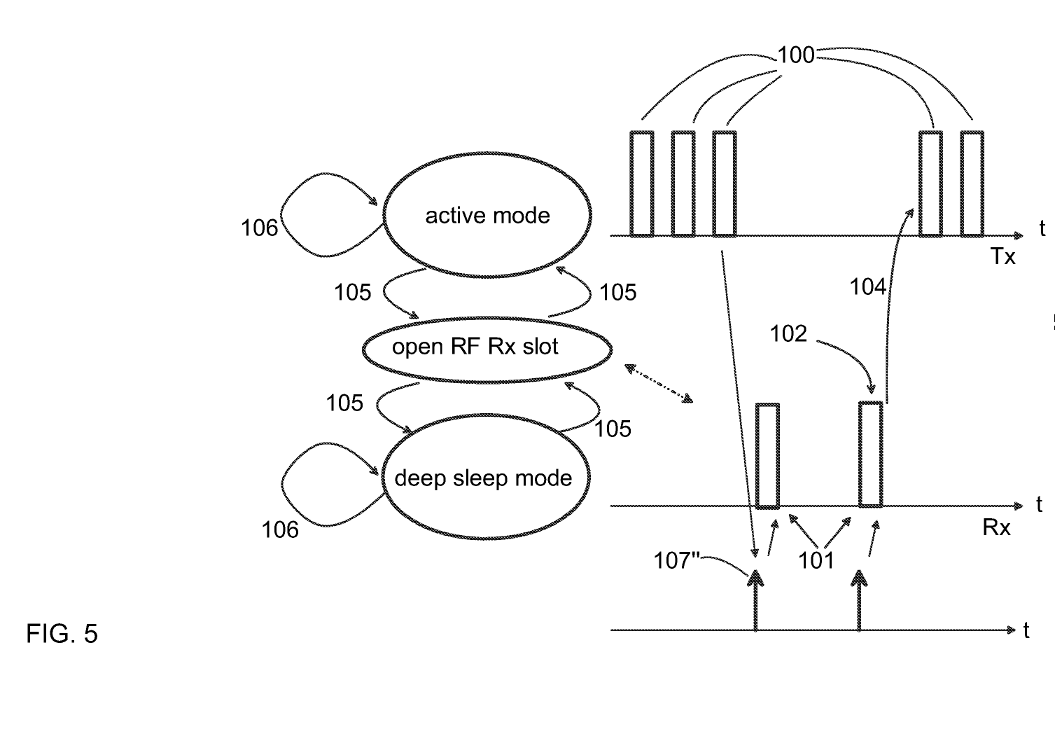

The working principle according to FIG. 5 is for both embodiments applicable. In case of the first embodiment the low frequency detector 20, 30, 40 activates the RF receiving path of the active tag 1. The RF receiving path of the active tag 1 is then powered up during a very short period of time, long enough to receive an incoming message 102 as depicted in FIG. 5. The incoming message 102 that follows the low-frequency activation 107″ is sent when the listening window 101 is activated. It consists of an RF instruction 102, intrinsically safe, that instructs the active tag 1 to behave in the way requested, typically wake-up from the deep sleep mode. The wake-up command 102 can be used for instance to trace a plurality of tags 1. The RF instruction 102 may also request the tag 1 to switch to a different interval of beaconing time, or to perform some internal checks to retrieve the different status of operation of the tag 1 and send them on the RF link. May the tag 1 be fitted with a sensing and logging unit, the RF instruction 102 may also request the tag 1 to dump the data from the memory. As described above an instruction regarding the operation of the tag is also called a configuration command 102.

The message flow according to FIG. 5 may additionally contain:
the RF activation message 102 may be addressed specifically to a tag 1;
the RF activation message 102 may be broadcasted, therefore it does not require the prior knowledge of the specific address of the tag 1;
the RF activation message 102 instructs the tag 1 to provide its Identity ID on a RF specific channel, for registration purpose;
the RF activation message 102 instructs the tag 1 to change the way it operates, from Read Only to Read Write;
where the RF activation message 102 instructs the tag to change the way it operates, Read Write to Read Only;
the RF activation message 102 instructs the tag 1 to change the way it operates, like to switch to a different interval of transmission;
the RF activation message 102 instructs the tag 1 to change the way it operates, like to provide a single traceability instruction;
the RF activation message 102 instructs the tag 1 to dump the content of its memory; and
the RF activation message 102 can be broadcasted the same instruction to a plurality of tags 1 receiving the wake-up pulse 107.

The before mentioned RF activation messages 102 instructing the tag 1 in a specific way are also called <<configuration commands>> 102. Even a configuration command allows at least a temporarily switching to an active mode. So such a configuration command can be regarded as a special embodiment of a wake-up command.

The operation according to the invention provides a very safe way to switch the active tag 1 from the active mode, back to a deep sleep mode without any significant energy consumption. In case of accidental LF activation by a parasitic spike, the active tag 1 shall activate its receiving RF section and wait for a valid incoming RF message 102. In case this message 102 is not detected, the tag 1 falls back into the deep sleep mode in which it was previously. This one time wake-up of the receiving section of the RF is not relevant to the overall energy consumption of the active tag.

1. A method for switching an active RFID tag from a deep sleep mode into an active mode, the method comprises the steps of:
providing the active RFID tag with a microcontroller, an antenna, a transmitter connected with the antenna, and a battery; and
providing a detector connected to the active RFID tag for receiving an external energy pulse providing a wake-up pulse to the microcontroller, the wake-up pulse having an effect of opening a brief radio frequency listen window allowing the active RFID tag to receive a message containing an instruction to switch to an active mode.

2. The method for switching the active RFID tag according to claim 1, which further comprises forming the detector as a low-frequency magnetic field detector embedded on the active RFID tag for receiving the external energy pulse being a low-frequency trigger providing the wake-up pulse to the microcontroller.

3. The method for switching the active RFID tag according to claim 2, which further comprises forming the low-frequency magnetic field detector as a coil.

4. The method for switching the active RFID tag according to claim 2, which further comprises setting the low-frequency trigger to be below 30 MHz.

5. The method for switching the active RFID tag according to claim 1, which further comprises receiving the external energy pulse by capacitive coupling and forming the detector with two plates.

6. The method for switching the active RFID tag according to claim 5, which further comprises disposing the plates on outer sides of a plastic case and both of the plates are separated by the plastic case.

7. The method for switching the active RFID tag according to claim 1, which further comprises supplying the message for instructing the active RFID tag to provide its identity on a RF specific channel for registration purposes.

8. The method for switching the active RFID tag according to claim 7, which further comprises broadcasting the message to a plurality of active RFID tags.

9. The method for switching the active RFID tag according to claim 2, which further comprises setting the low-frequency trigger to be 125 kHz.

10. The method for switching the active RFID tag according to claim 2, which further comprises setting the low-frequency trigger to be 13.56 MHz.

11. An active RFID tag, comprising:
a microcontroller;
an antenna;
a transmitter connected to said antenna;
a battery; and
a detector for receiving an external energy pulse providing a wake-up pulse to said microcontroller, the wake-up pulse having an effect of opening a brief radio frequency listen window allowing the active RFID tag to receive a message containing an instruction to switch to an active mode.

12. The active RFID tag according to claim 11, wherein said detector is a low-frequency magnetic field detector embedded on the active RFID tag for receiving the external energy pulse being a low-frequency trigger providing the wake-up pulse to said microcontroller.

13. The active RFID tag according to claim 12, wherein said low-frequency magnetic field detector is a coil.

14. The active RFID tag according to claim 12, wherein the low-frequency trigger is below 30 MHz.

15. The active RFID tag according to claim 11, wherein said detector is formed by two plates for receiving the external energy pulse by capacitive coupling.

16. The active RFID tag according to claim 15, further comprising a plastic case, said plates are disposed on outer sides of said plastic case and are separated from each other by said plastic case.

17. The active RFID tag according to claim 12, wherein the low-frequency trigger is in a range of 125 kHz to 13.56 MHz.

18. The active RFID tag according to claim 12, wherein the low-frequency trigger is 125 kHz.

19. The active RFID tag according to claim 12, wherein the low-frequency trigger is 13.56 MHz.
